(19) United States
(12) Patent Application Publication
(10) Pub. No.: US 2008/0004361 A1
(43) Pub. Date: Jan. 3, 2008

(54) Composite Material Based on a Biding Resin, Production Processes and Uses Thereof

(75) Inventor: Raffaele Palermo, Pietradefusi (AV) (IT)

Correspondence Address: ROBERTS, MLOTKOWSKI & HOBBES, P. O. BOX 10064, MCLEAN, VA, 22102-8064, US

(73) Assignee: TEKNO GARDEN S.R.L., Pietradefusi (AV) (IT)

(21) Appl. No.: 11/572,543

(22) PCT Filed: Jul. 21, 2005
(86) PCT No.: PCT/IT05/00424

§ 371 Date: Jan. 23, 2007

(30) Foreign Application Priority Data
Jul. 23, 2004 (IT) RM2004A000375

(51) Int. Cl. C08L 75/04; C08J 5/04; C08K 7/00

(52) U.S. Cl. 521/160

(57) ABSTRACT

The invention concerns a composite material based on polyurethanes foams, polyurethanes-polyisocyanurates foams, polyureic foams and/or mixtures thereof, wherein an inert material is dispersed in an amount between 0.1% and 90% of the total volume. The invention further concerns some production methods of said composite material and some uses thereof.

The present invention concerns a composite material based on a binding resin, production processes and uses thereof.

More in particular the invention refers to the field of preparation of manufactured products in composite material, light or not, having an excellent heat and sound insulating features, excellent physical-mechanical features and fire resistance.

At present, different kinds of manufactured products based on synthetic resins are commonly on trade.

In particular manufactured products based on expanded polyurethane or mixture of expanded polyurethane and expanded polyisocyanurate are particularly diffused.

In various industrial fields, such as furnishing, transports (by land, sea or air), building construction, are needed materials that allow to realise manufactured products with specific features, such as moisture and/or chemical agents resistance, or also the attitute to be treated by finishing by application of plaster or decorations (in the building construction field).

The applicant developed composite materials based on binding resins, which allow reaching these aims.

It is in this context that is proposed the solution according to the present invention aiming at providing a composite material based on binding resins, in particular polyurethanes foams, polyurethanes-polyisocyanurates foams, polyureic foams and/or mixtures thereof, having a specific formulation and a related method for the preparation of manufactured products obtainable by means of said composite materials. In particular, final manufactured products realised with the composite material of the present invention that can be light or not, and have an excellent heat and sound insulating features, excellent physical-mechanical features and fire resistance.

It is therefore a first specific object of the present invention a composite material based on polyurethanes foams, polyurethanes-polyisocyanurates foams, polyureic foams and/or mixtures thereof, wherein it is dispersed an amount of inert materials comprised between 0.1% and 90% of the total volume.

Preferably, according to the invention, said inert materials are chosen amongst expanded clay, wood derivates, carbon fibres and related fabrics and mats thereof, glass fibres and fabrics thereof, flakes, mats, metallic fibres, natural fibres and fabrics thereof, flakes, pinnacles, synthetic fibres and fabrics thereof, flakes, pinnacles, volcanic lapilli and derivates thereof, thermoexpanded hollow microcapsules with very low specific weight (15-90 kg/m3), perlite, polystyrene, melamine dusts and derivates thereof, pumice stone, rocks and derivates thereof, sawdust and derivates thereof, cork and derivates thereof, fabrics/felts/interline and derivates thereof with good flame resistance and heat insulation features, vermiculite, discharges of previous composite material's production cycles and mixtures thereof.

The width of the composition percent range is due to different grain size, specific weights and physical state of the inert materials.

The choice of inert materials (used alone or in mixture) and their amount to be used in the composite material according to the invention, must be correlated to the final desired specifications of the realised product as far as relative density, physical and mechanical features, fire resistance features, sound and/or heat insulating features is concerned.

The choice of the inert material or of the mixtures of inert materials follows the following conditions: performance, costs, and easiness of use together with other materials of the desired composite material.

More precisely, according to the performance condition the preferred inert materials are expanded clay, carbon fibres and derivates thereof, glass fibres and derivates thereof, perlite, melamine dusts and derivates thereof, fabrics/felts/interline and derivates thereof having good flame resistance and heat insulation features, vermiculite, since these materials allow to exalt mechanical—thermal features, sound insulation and fire resistance.

Following the economic condition, amongst inert materials are preferred for example wood and derivates thereof, polystyrene, sawdust and derivates thereof, discharges of previous production cycles, physical-mechanical features being sacrificed in this case.

When it is desired to select inert materials that are easy to use in the production of moulded articles, it is requested a choice aiming at the use of slightly abrasive inert materials, which are easily wettable by the components constituting the polymerisation reaction, such as wood derivates, expanded clay, melamine dusts, sawdust and derivates thereof.

Further, it is a second specific object of the present invention a first method of production of the composite material as defined in claims 1-2, through the following steps:

a) mixing, at environmental pressure and temperature below 40° C., for a period between 30 minutes and 1 hour, a binding resin obtainable from the following components:
30-90% by weight of a mixture of various polyoils, polyethers and/or polyesters and/or oligomeric diamines,
1-5% by weight of a catalizer,
3-20% by weight of a cross-linking agent,
2-4% by weight of a stabiliser,
2-10% by weight of a superfluidifier,
3-20% by weight of a fire retardant agent,
0-6% by weight of a expanding agent,
0-5% by weight of a dye;

b) adding to the mixture, at a temperature between 20° C. and 40° C., 30-250 parts by weight, with reference to 100 parts by weight of the mixture of step a), of MDI polymeric isocyanate (or a pre-polymer thereof);

c) further adding to the mixture an amount between 0.1 and 90% of the total volume, of an inert material, as defined in claims 2;

d) allowing the polymerisation of the mixture, at a temperature between 25° C. and 60° C. for a period between 5 and 45 minutes;

e) allowing the polymerisation to complete through stabilisation and curing for a period between 2 and 8 hour, in a dryer at a temperature between 60° C. and 110° C., or for a time up to 80 hours (incremented in order to include the methods wherein step a) occurs at a temperature over 35° C.), at environment conditions.

Preferably, according to the invention, said polyoils, polyethers and/or polyesters of the binding resin are chosen amongst those having a molecular weight between 200 and 6000; said oligomeric diamines are chosen amongst those having an equivalent weight between 200 and 800; said cataliser is chosen amongst tertiary aliphatic amines, metallic materials based on bismuth or tin, quaternary ammonium salts, potassium salts; said cross-linking agent is chosen amongst ethilenglycols and/or alkanolamides; said stabiliser is chosen amongst silica copolymers; said superfluidifier is chosen amongst phosphoric or carbonic acid esters; said expanding agent is chosen amongst water, carbon dioxyde, penthanes, dispersions of thermoplastic nature microcapsule containing liquids having low boiling point in a liquid vehicle; said 3-20 parts of a fire retardant agent being divided in 2-10 parts of a liquid fraction, chosen amongst oxydrilated resins containing bromine and phosphorus, and 1-10 parts of a solid fraction, chosen amongst aluminium trihydrate and/or magnesium oxydes and/or melamine dusts of various grain size; said dye being of an organic and/or inorganic nature.

Preferably, always according to the invention, the temperature during said step a) of said method is lower than or equal to 35° C.

Acting at operating temperatures lower than/equal to 35° C. allows to prevent various polyoils, polyethers and/or polyesters and/or oligomeric diamines, together with the cataliser and the cross-linking agent, from reacting too quickly. Consequently, at a temperature lower than/equal to 35° C. an improvement of fluency features (hence of the ability to fill the mold) is obtained and the abnormal inclusion of air bubbles (which would impair mechanical and thermal features of moulded articles) is effectively prevented.

On the other hand, high temperature could contrast with the stabiliser, causing the deterioration of cell structure and the worsening of the mechanical and thermal features of moulded articles, and further with the expanding agent, causing difficulties to the repeatability of the system expansion density with the possibility of causing anomalies in the filling of the mould and/or form and in the cell structure homogeneity, and consequent alterations of thermal and mechanical features.

Therefore, it is possible, if the temperature during said step a) is maintained below 35° C., to obtain a composite material according to the invention, having excellent features, residence times of the manufactured product in the mould and/or form being approximately 7-10 minutes shorter and lowering the curing and stabilisation time of 3-4 hours.

On the other side, if the temperature during said step a) is not maintained below 35° C., it is advisable to use amounts of said various polyoils, polyethers and/or polyesters and/or oligomeric diamines, of said cataliser and of said cross-linking agent close to the minimum of the respective composition ranges, increasing permanence time of the manufactured product in the mould and/or form and increasing the curing and stabilisation time. However, by working with these conditions, the time needed for the working process to complete is increased and in particular the permanence time in the mould and/or form is increased. In order to produce the same number of manufactured products per time unit it would be necessary to have the use of a greater number of moulds and/or forms, with a consequential increase in the investment costs.

With reference to the composition range of the component added in step b) of the method, the amount of said polymeric isocyanate or of a related pre-polymer is determined on the base of a reaction balance considering the amount of NCO (isocyanate) groups in said component and of OH (reactive hydroxyl) group in the different polyoils and reagents involved in each specific mixture, in order to use stoichiometric indexes between 90 and 300.

The selection of the inert material/materials and its amount in the final material is made, not only on the base of considerations related to the desired product, as previously seen, but also on the base of process needs, taking into account that the inert material nature and its amount determine the easiness of processing the reacting mixture in liquid phase, since system viscosity variables intervenes together with the wettability of the same inert materials.

Amongst the inert materials helping the processability of the reacting mixture in liquid phase, in particular in the production of moulded articles, are preferred those lightly abrasive and easy to be wetted by the components constituting the polymerisation reaction, such as wood derivates, expanded clay, melamine dusts, sawdusts and related derivates.

Preferably, according to the invention, said method for the production of a composite material as previously defined provides for said inert material being preliminarly arranged in a mould, wherein it is subsequently poured the mixture obtained according to phases a) and b) of the method, mixing in order to obtain a controlled distribution of the inert material in the mixture.

Alternatively, said method for the production of a composite material as previously defined provides for said inert material being preliminarly added to the mixture obtained according to the phase a) and mixed before said phase b). In this case, according to the invention, said inert material being preliminarly added to the mixture obtained according to phase a) is chosen amongst wood derivates, synthetic fibres, melamine dusts and derivates thereof, sawdust and derivates and mixtures thereof.

Again, said method for the production of a composite material as previously defined can alternatively provide for said mixture obtained according to the phases a) and b) of the method being used to soak a substrate of an inert material, for example a fabric-felt.

It is further a third specific object of the present invention a composite material obtainable through the method as previously defined.

It is further a fourth specific object of the invention a binding resin as obtainable through said step a) of said method, in the absence of the expanding agent.

It is a fifth specific object of the present invention the use of the binding resin as previously defined as a finishing and/or coating material.

In fact, in the case a mixture without the expanding agent is prepared, it could be used by spraying as a finishing and/or coating paint; as a compact material to realise rims and profiles of manufactured products; as a filling and binding resin together with various inert materials in order to produce manufactured products having low thickness and high physical-mechanical features and an excellent tensile strength with respect to static and dynamic forces; as a binding resin, by means of pressing, of recycled raw materials (flakes, wastes, fibres, granules).

It is further a sixth specific object of the present invention a second method for the production of a composite material as previously defined, through the following steps:

a′) mixing, at environment temperature and pressure, for a period between 2 and 5 minutes, a binding resin obtainable from the following components:
40-60% by weight of a combination of an hardening dust based on silica added with hardening agents selected from the group comprising esters of polyhydroxylic alcohols and esters of alkylene carbonates,
the remaining part being constituted by water and admixtures such as refractory clays based on aluminium silicate and/or organic and inorganic binders such as hydrates based on silicates, water-repellent agents,

b′) adding an amount between 0.1% and 90% of the total volume, of an inert material, as defined in claim 2;

c′) pouring said mixture in a mould, or soaking a substrate of inert material, such as a fabric-felt, with said mixture;

d′) allowing the polymerisation of the mixture, at a temperature between 15 and 35° C. for a period between 3 and 4 days;

e′) completing the polymerisation through stabilisation and curing for a period between 1 and 3 days, in a dryer at a temperature between 60 and 80° C., or for a period up to 15 days, at environment conditions.

It is then a seventh specific object of the present invention a composite material obtainable by means of said second method as previously defined.

It is further an eighth specific object of the present invention a third method for the production of a composite material as defined in claims 1-2, comprising the following steps:

a″) mixing, at environment pressure and temperature, for a period between 2 and 5 minutes, a binding resin obtainable from the following components:
40-60% by weight of a combination of hardening dust based on silica added with hardening agents selected from the group comprising esters of polyhydroxylic alcohols and alkylene carbonates esters,
the remaining part being constituted by water and admixtures such as refractory clays based on aluminium silicate and/or organic and inorganic binders such as hydrates based on silicates, water-repellent agents,

b″) adding an amount between 0.1% and 90% of the total volume, of an inert material, as defined in claim 2;

c″) pouring said mixture in a mould, or soaking with said mixture a substrate of inert material, such as a fabric-felt;

d″) allowing the polymerisation of the mixture, at a temperature between 15 and 35° C. for a period between 3 and 4 days;

e″) completing the polymerisation through stabilisation and curing for a period between 1 and 5 days, in a dryer at a temperature between 60 and 100° C.;

f″) separately mixing together, at environmental pressure and at a temperature below 40° C., for a period between 30 min and 1 h, a binding resin obtainable from the following components:
30-90% by weight of a mixture of various polyoils, polyethers and/or polyesters and/or oligomeric diamines,
1-5% by weight of a cataliser,
3-20% by weight of a cross-linking agent,
2-4% by weight of a stabiliser,
2-10% by weight of a superfluidifier,
3-20% by weight of a fire retardant agent,
0-6% by weight of an expanding agent,
0-5% by weight of a dye;

g″) adding to the mixture, at a temperature between 20° C. and 40° C., 30-250 parts by weight, with respect to 100 parts by weight of the mixture of step f″), of a MDI polymeric isocyanate (or a pre-polymer thereof);

h″) pouring in a mould, whose walls were covered with a layer of a material obtained by means of the phases from a″) to e″), an amount between 0.1% and 90% of the total free volume of the mould of an inert material, as defined in claim 2;

i″) pouring in the same mould a mixture as obtained by means of the phases f″) and g″);

l″) allowing the polymerisation of the mixture, at a temperature between 25° C. and 60° C. for a period between 5 and 45 minutes;

m″) allow the polymerisation to complete through stabilisation and curing for a period between 2 and 8 hours, in a dryer at a temperature between 60° C. and 110° C., or for a period up to 80 hours, at environment conditions.

Preferably, according to the invention, in the mixture of phase f″) of said method, said polyoils, polyethers and/or polyesters are chosen amongst those having a molecular weight between 200 and 6000; said oligomeric diamines are chosen amongst those with equivalent weight between 200 and 800; said cataliser is chosen amongst tertiary aliphatic amines, metallic materials based on bismuth or tin, quaternary ammonium salts, potassium salts; said cross-linking agent is chosen amongst ethilenglycols and/or alkanolamides; said stabiliser is chosen amongst silica copolymers; said superfluidifier is chosen amongst phosphoric or carbonic acid esters; said expanding agent is chosen amongst water, carbon dioxyde, penthanes, dispersions of microcapsules of thermoplastic nature containing liquids having low boiling point in a liquid vehicle; said 3-20 parts of a fire retardant agent are comprised of 2-10 parts of a liquid fraction, chosen amongst oxydrilated resins containing bromine and phosphorus, and of 1-10 parts of a solid fraction, chosen amongst aluminium trihydrate and/or magnesium oxydes and/or melamine dusts of various grain size; and said dye can have an organic and/or inorganic nature.

It is therefore a ninth specific object of the present invention a composite material obtainable by means of said third method as previously defined.

The claimed methods are only illustrative and non limitative of the solutions according to the present invention, the following alternatives being considered as equivalent:

combining by means of molding, casting, stratification, glueing, pressing, injection, the reacting components;

spraying the surfaces of a mould with a mixture as obtainable according to the phases a) and b) of the first production method (i.e. in absence of expanding agents), in order to obtain a good soft and/or hard superficial finishing, pleasant to touch, neither sticky nor greasy, resistant to abrasion, chemical agents, easy to clean and having a high resistance to hydrolysis, and subsequent molding and/or injection in the same mould of a different mixture, comprising inert materials, according to one of the mixtures and methods of the invention;

free open sky casting in a predefined mould and/or form;

casting in a predefined closed mould and/or form;

castings with use of preformed or not forms, with fabrics and/or plastic films such as PVC, polyurethane or polyethylene, or by means of vacuum aspiration of the same forms in a specific mould;

casting in a mould and/or form with external application, on one or both sides, of finishing plates with sheets of veneer or compressed materials such as wood, cork, plastic laminates, melaminic papers, aluminium, steel;

continuously or discontinuously casting by means of transport and/or automatic advancing with the possibility of finishing with coating or without coating of one or both the sides for the production sandwich panels with flexible faces (paper, felt paperboard, paperboard and polythene glass) or rigid faces (aluminium, copper, steel, iron plates);

casting in a mould and/or form with external application, on one or both sides, of finishing plates with sheets of veneer or compressed materials such as wood, cork, plastic laminates, melaminic papers, aluminium, steel, with subsequent repositioning of the produced article in a further mould for a subsequent casting, useful to perfectly border and/or link both the external faces of the same manufactured product, providing the same with a good finishing and an excellent aesthetic appearance;

casting in a predefined mould with a programmed flow, by means of canalisations or areas prepared beforehand in order to obtain manufactured products with various density (minimum value 30 g/dm3-maximum value 600 g/dm3) and settled for producing a component and/or manufactured product having two or more different density;

working the components and/or semifinished products to pair or combine with a binding resin, by means of manual impregnation, with compression and injection with possible use of autoclave or vacuum pump.

Further, when it is necessary to produce big size manufactured products (panels whose length ranges from a minimum of 100 cm and a maximum of 250 cm, whose height ranges from a minimum of 50 cm and a maximum of 110 cm, whose thickness, even if not uniform, ranges from 3 cm to 35 cm, volume to fill more than 75 litres), it is possible to use the following production processes:

moulding with multiple casting;

moulding with multiple head;

moulding using a flexible plastic pipe (internal dimensions equal to the exit dimensions of the mixing chamber or of the mixing head, diameter from 18 to 30 mm and maximum length 220 cm) positioned inside the mould and/or form in order to uniform to the best the distribution of the reacting mixture while it is still in a liquid phase and improving flows and fillings.

A particular moulding solution comprises the use of a specific plant, provided with two independent lines of a component based on polyoils (component of the phase a) of the first production method and of the phase f″) of the third production method) with double formulation with different reactivity, by using different percentages of the components of the mixtures, of one or more independent lines of MDI polymeric isocyanate and/or a related pre-polymer thereof (component of phase b) of the first method and of phase g″ of the third method) (when using two separate lines the used product can have different NCO and/or chemical-physical features).

Besides, particular solutions to optimise the features of the final manufactured product can comprise a partial or complete rotation of the mould and/or form and its repositioning in the starting position, in a period not exceeding the time needed for the beginning of the phase of expansion (between about 5 and 15 seconds) of the mixture of reacting components, in order to maximise the “wettability” of the present inert materials, improving their flowing, helping the exit of the air and making the manufactured product density more uniform.

Further, using a pump in order to obtain a vacuum in the closed mould and/or form, before and/or during the phase of expansion of the reacting components mixtures, improves the flowing, helps the exit of the air and makes the manufactured product density more uniform. In this case, a double filter with tiny mesh, positioned at the exit of the mould, is necessary in order to prevent the aspiration of inert materials.

The use of panels (minimum thickness 2 mm, maximum 25 mm, depending on the material), made of laminate, chip, agglomerate wood, panels realised with wood fibres and/or derivates thereof, melaminic laminates and derivates thereof, metallic plates, made for example of aluminium or steel, plastic material plates, such as PVC, polypropylene, ABS, polystyrene, positioned in order to totally cover both the lateral faces of the forms and/or moulds, allows for realising manufactured products having thickness even higher than 35 cm, length beyond 250 cm, height higher than 110 cm.

All the production methods previously described allow for the introduction of joins having various form or dimension, in plastic material (such as PVC, ABS, polyamide, polypropylene), metallic material (steel, aluminium), wood and others, which can provide for a manufactured product easy to mount and/or assemble.

The invention will now be described for illustrative and not limitative purpose, with reference to some illustrative examples. In the examples are used some letters in order to identify different categories of components, in order to help to identify similar components of different examples.

### EXAMPLE 1

In order to realise manufactured products based on PUR-PIR (i.e. polyurethane-polyisocyanurate) expanded resins, two mixtures were prepared, at environment conditions (20° C. temperature and humidity about 45%):

component A (35% by weight): polyoils mixture and related admixtures, constituted by polyether having molecular weight between 200 and 6000 (29.00% by weight), an oxydrilated resin containing bromine (3.00% by weight), an aliphatic aminic cataliser (0.30% by weight), a cataliser based on potassium salts (1.00% by weight), a siliconic surfactant (0.70% by weight), water (1.00% by weight);

component B: MDI polymeric isocyanate (65% by weight)

Separately a mixture of inert materials (component C) was prepared, the mixture being composed by 2 parts in volume of perlite and 1 part in volume of expanded clay (basic weight 6/8 mm), by mixing with a blade plunger, whose speed was 70 rounds per minute for 2 minutes. The mixture of inert materials was arranged, by means of a graduated carafe, in an aluminium mould at a temperature of 35° C., in an amount filling 30% of the volume of the mould.

Component A and component B were mixed by means of a two components low pressure foaming machine, wherein the pressure and the temperature of the components were respectively equal to 20 atm and 23° C. for component A and 8 atm and 23° C. for component B, by means of a static mixer at 6000 round/min. At the same time, the mixture of components A and B was cast in the mould, by means of a particular rack distributor (a pipe made by steel, inferiorly closed, 35 mm long, whose internal diameter was 20 mm, having a reversed T form, with twelve openings on the lower portion, six central openings having a diameter of 1.5 mm and 6 lateral opening having a diameter of 2 mm), until the complete filling of the same mould (i.e. filling the 70% of the volume of the mould, in the remaining portion being present the mixture of inert materials). The flow rate of said distributor was 150 g/s.

Through said procedure a panel whose thickness was 20 mm, and whose dimensions were 400×600 mm was realised.

After 25 minutes from the casting, the article was removed from the mould, the manufactured product was allowed to stabilise at environment temperature for a period of about 5 hours.

The consequently obtained manufactured product is rather light (average specific weight of 75 g/dm3) and has an excellent resistance to hydrolysis, a good mechanic strength (in particular with respect to torsion), good heat and sound insulation.

In particular, the manufactured product has an excellent dimensional stability both at +70° C. than at −30° C., has an amount of closed cells equal to or higher than 90%, a thermal conductivity at 23° C. equal to 0.032 W/(m·K), a water absorbancy at 20° C. lower than or equal to 2%. The fire resistance features of the obtained manufactured product allow him to be classified in class 1 according to Italian law.

### EXAMPLE 2

In order to realise manufactured products in composite material based on expanded polyurea, the following mixtures were prepared at environment conditions (temperature 25° C., humidity rate about 40%):

component A (65% by weight): mixture constituted by aminobenzoate polytetramethylene oxyde (61.5% by weight), an aminic aliphatic cataliser (0.50% by weight), a siliconic surfactant (1.00% by weight) and water (2.00% by weight)

component B (35% by weight): MDI polymeric isocyanate

Separately, by means of a graduated carafe, polystyrene having basic weight 4/8 mm (component C) was poured in an aluminium mould, at a temperature of 50° C., filling 60% of the volume of the same mould.

Component A and component B were mixed by means of a two components low pressure foaming machine, wherein the pressure and the temperature of the components were respectively equal to 20 atm and 25° C. for component A and 10 atm and 23° C. for component B, by means of a static mixer at 7000 rounds/min. At the same time, the mixture of components A and B was cast in the mould, by means of a particular rack distributor (identical to that of example 1), until the complete filling of the same mould (i.e. filling the 40% of the volume of the mould, in the remaining portion being present polystyrene). The flow rate of said distributor was 160 g/s.

Through said procedure a panel whose thickness was 20 mm and whose dimensions were 400×600 mm was realised.

After 15 minutes from the casting, the article was removed from the mould, the manufactured product was allowed to stabilise at environment temperature for a period of about 3 hours.

The consequently obtained manufactured product was particularly light (it can float in water) and has an excellent resistance to hydrolysis, a good mechanic strength (in particular with respect to torsion) good heat and sound insulation. Further, the manufactured product has an excellent dimensional stability, both at +70° C. and at −30° C., has an amount of closed cells equal to or higher than 90%, a resistance to compression at 10% flession higher than/equal to 0.45 MPa, a thermal conductivity at 23° C. of 0.031 W/(m·K), water absorbancy at 20° C. lower than/equal to 1.5%.

Manufactured product fire resistance features allow to classify it in class 1 according to Italian law.

### EXAMPLE 3

Two mixtures were prepared, at climatic conditions, i.e. at a temperature of 27° C. and humidity about 60%:

component A: mixture of oligomeric diamines and admixtures (66% by weight, constituted by aminobenzoate polytetramethylene oxyde (61.50% by weight), an aminic aliphatic cataliser (0.50% by weight), a siliconic surfactant (1.00% by weight) and water (3.00% by weight));

component B: MDI polymeric isocyanate (34% by weight)

Separately two plates were prepared having same dimensions and made of melaminic laminate, internally coated, by means of soaking, with a fabric-felt having basic weight of 280 g/m2 (component C) and soaked with an inorganic resin (component D, based on two components, the first component being a combination of hardening dust based on silica, added with a hardening agents selected from the group comprising polyhydroxylic alcohol esters and alkylene carbonates esters, the second component being constituted by water and further admixtures such as particular refractory clays based on aluminium silicate and/or organic and inorganic binders such as hydrates based on silicates, water-repellant agents) having the following composition:

Reagent 1 (55% by weight): product marketed with the name REA 503 PL by Resinteco, in dust

Reagent 2 (45% by weight): product marketed with the name REA 600 SL by Resinteco, liquid

The plates were hardened and cured in oven at 70° C.

A mould of aluminium was prepared, whose faces were covered by the plates, by means of vacuum. Some polystyrene, having basic weight ⅖ mm, was introduced inside the mould (at 40° C.), by means of a graduated carafe, filling 50% of the volume of the mould.

Component A and component B were mixed by means of a two components low pressure foaming machine, wherein the pressure and the temperature of the components were respectively equal to 20 atm and 25° C. for component A and 10 atm and 23° C. for component B, by means of a static mixer at 7000 rounds/min. At the same time the mixture of components A and B was cast in the mould, by means of a particular rack distributor (identical to that of example 1), until the complete filling of the mould, thus realising a panel whose thickness is 28 mm and whose dimensions are 400×600 mm.

After 30 minutes from casting the article was removed from the mould, the manufactured product was allowed to stabilise at an environment temperature for a period of about 3 hours.

The consequently obtained manufactured product was tested and has an excellent resistance to hydrolysis, a good mechanic strength (in particular with respect to torsion) good heat and sound insulation, it is very light, and floats in water.

Further, the manufactured product has an excellent dimensional stability, both at +70° C. and at −30° C., has an amount of closed cells higher than/equal to 93%, water absorption at 20° C. lower than/equal to 1.65%.

The realised manufactured product, when exposed to flame, turns out to be particularly resistant.

### EXAMPLE 4

In order to realise manufactured products based on PUR-PIR (i.e. polyurethane-polyisocyanurate) expanded resins, two mixtures were prepared, at a temperature of 27° C. and humidity about 60%:

component A: mixture of polyoils and related admixtures (35% by weight), comprising polyether polyoils having molecular weight between 200 and 6000 (29.00% by weight), oxydrilated resin containing bromine (3.00% by weight), an aminic aliphatic cataliser (0.30% by weight), a cataliser based on potassium salts (1.00% by weight), a siliconic surfactant (0.70% by weight), water (1.00% by weight);

component B: MDI polymeric isocyanate (65% by weight)

Separately a third mixture (coating) was prepared, based on polyoils and related admixtures, i.e. polyether polyoils having molecular weight from 200 to 6000 (81% by weight), 1,4-butanediol (13% by weight), a metallic cataliser based on tin (1% by weight), a liquid fire retardant agent (4% by weight), an organic dye (1% by weight).

Finally, a fourth mixture was prepared based on MDI polymeric isocyanate (NCO 23-30) (97% by weight) and a liquid fire retardant agent (3% by weight).

The third and fourth mixtures were sprayed, at the same time and in the same amount, by means of a particular spray device, on both internal faces of a mould made of epossidic resin, at a temperature of 30° C. In particular, the used spray device is a two components device, having independent lines and mixing at the head, in order to grant that the percentage amount by weight of the third and fourth mixture were sprayed in an amount of 50% of the total.

Component A and component B were mixed by means of a two components low pressure foaming machine, wherein the pressure and the temperature of the components were respectively equal to 15 atm and 25° C. for component A and 7 atm and 25° C. for component B, by means of a static mixer at 6000 rounds/min. The mixture of components A and B was cast in the mould at the same time, in order to realise the seat of a stool having an average thickness of 38 mm and maximum external dimensions of 300×350 mm.

After 8 minutes from casting the article was removed from the mould, the manufactured product was allowed to stabilise at environment temperature for a period of about 3 hours.

The consequently obtained manufactured product was tested and turns out to have an excellent resistance to hydrolysis, a good mechanical strength (in particular with respect to abrasion and to breaking).

Further the manufactured product has the following features: an excellent dimensional stability both at +70° C. and at −30° C., water absorption at 20° C. lower than/equal to 1%. Its fire resistance features allow him to be classified in class 1 according to Italian law.

The consequently obtained manufactured product is particularly light, can float in water, has an excellent superficial finishing and is pleasant to touch.

### EXAMPLE 5

Two mixtures were prepared, at a temperature of 22° C. and humidity about 55%:

component A: mixture of polyoils and related admixtures (30% by weight), comprising: polyether having molecular weight between 200 and 6000 (25.00% by weight), an oxydrilated resin containing bromine (2.00%), an aminic aliphatic cataliser (0.30% by weight), a cataliser based on potassium salts (1.00% by weight), a siliconic surfactant (0.70% by weight), water (1.00% by weight);

component B: MDI polymeric isocyanate (70% by weight)

Separately, two panels were prepared, having thickness of 15 mm and same dimensions, made from a resin composed of a mixture of chemical products having inorganic base (component D), with reacting components (a first reagent made of a hardening dust based on silica added with hardening agents selected from the group comprising polyhydroxylic alcohol esters and alkylene carbonates esters (product marketed with the name REA 503 PL by Resinteco and a second liquid reagent constituted by water and admixtures such as refractory clays based on aluminium silicate and/or organic and inorganic binders, such as hydrates based on silicates, and water-repellent agents (product marketed with the name REA 600 SL by Resinteco, and perlite (an inert material), according to the following composition:

first reagent (28% by weight) (40% by weight of component D)

second reagent (42% by weight) (60% by weight of component D)

inert material (perlite) (30% by weight) (component C).

Both panels were obtained by means of a form, by pouring in a container the mixture of the first and second reagent, previously mixed, added with the determined amount of perlite. The obtained mixture was blended by mixing in a helical or disc plunger (at least at 100 rounds/minute) for 2 minutes.

When the polymerisation of the components of the mixture is complete, both panels were removed from the form, hardened at environment temperature for two hours, and then cured and stabilised in oven at 70° C. for two days.

After, an aluminium mould was prepared, whose faces were coated with the panels. Some polystyrene (basic weight ⅖ mm) was introduced inside the mould, at a temperature of 35° C., by means of a graduated carafe, until filling 55% of the volume of the mould.

Component A and component B were mixed by means of a two components low pressure foaming machine, wherein the pressure and the temperature of the components were respectively equal to 20 atm and 22° C. for component A and 10 atm and 22° C. for component B, by means of a static mixer at 6500 rounds/min. The mixture of components A and B was cast in the mould at the same time, by means of a particular rack distributor (identical to that of example 1), whose flow rate was 180 g/s, until the complete filling of the mould, thus realising a panel whose thickness is 50 mm, and whose dimensions are 400×600 mm.

After 30 minutes from casting the article was removed from the mould, the manufactured product was allowed to stabilise at environment temperature for a period of about 3 hours.

The consequently obtained manufactured product was tested and turns out to have an excellent resistance to hydrolysis, a good mechanic strength (in particular with respect to torsion), good heat and sound insulation, is light. In particular, the manufactured product has an excellent dimensional stability both at +70° C. and at −30° C., has an amount of closed cells higher than/equal to 95%, water absorbancy at 20° C. lower than/equal to 1.4%.

The obtained manufactured product, when exposed to flame, turns out to be particularly resistant.

Finishing by means of plaster or decorations, allows the manufactured product to be employed in the building field. For example as an heat insulating material for attics, dividing wall, disposable wall in the form of reinforcement or caisson, as a component of a fire resistant shield for doors and bulkheads for vehicles or boats.

### EXAMPLE 6

A resin was prepared, at a temperature of 21° C. and humidity about 50%, by means of a helical or disk mixer at a minimum rotation speed of 100 rounds/min, comprising a mixture of chemical products having an inorganic phase (component D), with two reacting components (a first reagent constituted by a hardening dust based on silica added with hardening agents selected from the group comprising polyhydroxylic alcohol esters and alkylene carbonates esters (product marketed with the name REA 503 PL by Resinteco)) and a second liquid reagent constituted by water and admixtures such as refractory clays based on aluminium silicate and/or organic and inorganic binders, such as hydrates based on silicates, and water-repellent agents (product marketed with the name REA 600 SL by Resinteco)), according to the following composition:

first reagent (40% by weight)

second reagent (60% by weight).

Separately a layer of fabric—felt (component C) was prepared, having basic weight of 230 g/m2. The layer was cut, using a particular template, in order to take a determined size and shape.

The inorganic resin was placed, by means of stratification with paint roller and paint brush, over the fabric-felt, previously placed in a form-mould made by stratified polyester resin at a temperature of 30° C., in order to realise a shell having the shape of half spheric cylinder whose height is 50 cm and whose width is 30 cm.

After 30 minutes from the polymerisation ending, the article was removed from the form-mould, the manufactured product was subjected to stabilisation and curing in oven at a constant temperature of 90° C., for a period of 96 hours, until the complete drying and the subsequent final hardening of the manufactured product.

The use of a microwave oven dramatically decrease the time needed for curing and allows to realise products on an industrial scale.

The consequently obtained manufactured product was tested and turns out to have an excellent resistance to hydrolysis, a good mechanic strength, good heat and sound insulation. Further, it turns out to be light.

If exposed to a flame, the manufactured product turns out to be particularly resistant to high temperatures, even over 1300° C., without burning and without producing exhalations of toxic and/or harmful substances, and without producing fumes.

Using a combination of one of the following components: other inert materials (component C), PUR-PIR-Polyurea and/or mixtures thereof (component A), natural and/or synthetic fibres, metallic fibres, glass fibres, carbon fibre and derivates, natural and/or synthetic technical fabrics, it is possible to realise, on the base of the desired technical features, manufactured composite products with different chemical, physical and mechanical features.

Once they are subject to the above mentioned treatment, the panels can undergo:

finishing by means of plaster or decorations, allowing the manufactured product to be used in the building field, as an insulating material for attics, dividing wall, as a component of a fire resistant shield for doors and bulkheads;

production of components and/or various accessories for vehicles used to transport people and/or things such as land transportation (cars, trains, buses, cargos), sea transportation (ships, boats, ferry-boats), air transportation (planes, satellites, space vehicles), various industrial fields (furnishing, various components).

### EXAMPLE 7

A resin was prepared, at a temperature of 23° C. and humidity about 60%, by means of a helical or disk mixer at a minimum rotation speed of 100 rounds/min, made by a mixture of chemical products having an inorganic phase (component D), with two reacting components (a first reagent constituted by a hardening dust based on silica added with hardening agents selected from the group comprising polyhydroxylic alcohol esters and alkylene carbonates esters (product marketed with the name REA 503 PL by Resinteco)) and a second liquid reagent constituted by water and admixtures such as refractory clays based on aluminium silicate and/or organic and inorganic binders, such as hydrates based on silicates, and water-repellent agents (product marketed with the name REA 600 SL by Resinteco)), according to the following composition:

first reagent (45% by weight)

second reagent (55% by weight).

Separately a layer of fabric—felt (component C) was prepared having basic weight of 130 g/m2. The layer was cut, by means of a particular template, in order to take a determined size and shape.

The inorganic resin was placed, by means of stratification with paint roller and paint brush, over the fabric-felt, previously placed in a form-mould made by stratified polyester resin at a temperature of 30° C., in order to realise a wood panel whose thickness is 20 mm and whose dimensions are 800×400 mm.

Then, it was pressed by means of a hot plate press at a temperature of 60/70° C. After 35 minutes the moulded article was removed from the press and the manufactured product underwent stabilisation and curing, in oven at a constant temperature of 90° C. for a period of 96 hours, until the complete drying and the subsequent final hardening of the manufactured product.

The possible use of a microwave oven dramatically decrease the time needed for curing and allows realising products on an industrial scale.

The consequently obtained manufactured product was tested and, if exposed to a flame, the manufactured product turns out to be particularly resistant to high temperatures, even over 1000° C., without burning and without producing exhalations of toxic and/or harmful substances, and without producing fumes.

Using a combination of one of the following components: other inert materials (component C), PUR-PIR-Polyurea and/or mixtures thereof, natural and/or synthetic fibres, metallic fibres, glass fibres, carbon fibre and derivates, natural and/or synthetic technical fabrics, it is possible to realise, on the base of the desired technical features, manufactured composite products with different chemical, physical and mechanical features.

All wood panels and derivates thereof, laminates in steel, laminates in aluminium, metallic materials and derivates thereof, natural fibres and derivates, synthetic fibres and derivates apply to this application.

Once they are subject to the above mentioned treatment, the panels can undergo:

finishing by means of plaster or decorations, allowing the manufactured product to be used in the building field, as an insulating material for attics, dividing wall, as a component of a fire resistant shield for doors and bulkheads;

production of components and/or various accessories for vehicles used to transport people and/or things such as land transportation (cars, trains, buses, cargos), sea transportation (ships, boats, ferry-boats), air transportation (planes, satellites, space vehicles), various industrial fields (furnishing, various components).

The present invention was described for illustrative, but not limitative purposes, according to its preferred embodiments, but it is to be understood that changes and/or modifications can be made by those skilled in the art without for this departing from the related scope of protection, as defined by the enclosed claims.

1. Composite material based on polyurethanes foams, polyurethanes-polyisocyanurates foams, polyureic foams and/or mixtures thereof, wherein it is dispersed an amount of inert materials comprised between 0.1% and 90% of the total volume.

2. Composite material according to claim 1, wherein said inert materials are chosen amongst expanded clay, wood derivates, carbon fibres and related fabrics and mats thereof, glass fibres and fabrics thereof, flakes, mats, metallic fibres, natural fibres and fabrics thereof, flakes, pinnacles, synthetic fibres and fabrics thereof, flakes, pinnacles, volcanic lapilli and derivates thereof, thermoexpanded hollow microcapsules with very low specific weight (15-90 kg/m3), perlite, polystyrene, melamine dusts and derivates thereof, pumice stone, rocks and derivates thereof, sawdust and derivates thereof, cork and derivates thereof, fabrics/felts/interline and derivates thereof with good flame resistance and heat insulation features, vermiculite, discharges of previous composite material's production cycles and mixtures thereof.

3. Method for the production of a composite material as defined in claims 1-2, through the following steps:
a) mixing, at environmental pressure and temperature below 40° C., for a period between 30 minutes and 1 hour, a binding resin obtainable from the following components:
30-90% by weight of a mixture of various polyoils, polyethers and/or polyesters and/or oligomeric diamines,
1-5% by weight of a catalizer,
3-20% by weight of a cross-linking agent,
2-4% by weight of a stabiliser,
2-10% by weight of a superfluidifier,
3-20% by weight of a fire retardant agent,
0-6% by weight of a expanding agent,
0-5% by weight of a dye;
b) adding to the mixture, at a temperature between 20° C. and 40° C., 30-250 parts by weight, with reference to 100 parts by weight of the mixture of step a), of MDI polymeric isocyanate (or a pre-polymer thereof);
c) further adding to the mixture an amount between 0.1 and 90% of the total volume, of an inert material, as defined in claims 2;
d) allowing the polymerisation of the mixture, at a temperature between 25° C. and 60° C. for a period between 5 and 45 minutes;
e) allowing the polymerisation to complete through stabilisation and curing for a period between 2 and 8 hour, in a dryer at a temperature between 60° C. and 110° C., or for a time up to 80 hours (incremented in order to include the methods wherein step a) occurs at a temperature over 35° C.), at environment-conditions.

4. Method for the production of a composite material according to claim 3, wherein, said polyoils, polyethers and/or polyesters of said binding resin are chosen amongst those having a molecular weight between 200 and 6000; said oligomeric diamines are chosen amongst those having an equivalent weight between 200 and 800; said cataliser is chosen amongst tertiary aliphatic amines, metallic materials based on bismuth or tin, quaternary ammonium salts, potassium salts; said cross-linking agent is chosen amongst ethilenglycols and/or alkanolamides; said stabiliser is chosen amongst silica copolymers; said superfluidifier is chosen amongst phosphoric or carbonic acid esters; said expanding agent is chosen amongst water, carbon dioxyde, penthanes, dispersions of thermoplastic nature microcapsule containing liquids having low boiling point in a liquid vehicle; said 3-20 parts of a fire retardant agent being divided in 2-10 parts of a liquid fraction, chosen amongst oxydrilated resins containing bromine and phosphorus, and 1-10 parts of a solid fraction, chosen amongst aluminium trihydrate and/or magnesium oxydes and/or melamine dusts of various grain size; said dye being of an organic and/or inorganic nature.

5. Method for the production of a composite material according to any of claims 3 and 4, wherein the temperature of said step a) of said method is lower than or equal to 35° C.

6. Method for the production of a composite material according to any of claims 3-5, wherein said inert material is preliminarly arranged in a mould, wherein it is subsequently poured the mixture obtained according to phases a) and b) of the method, mixing in order to obtain a controlled distribution of the inert material in the mixture.

7. Method for the production of a composite material according to any of claims 3-5, wherein said inert material is preliminarly added to the mixture obtained according to said phase a) and mixed before said phase b).

8. Method for the production of a composite material according to claim 7, wherein said inert material that is preliminarly added to the mixture obtained according to phase a) is chosen amongst wood derivates, synthetic fibres, melamine dusts derivates thereof, sawdust and derivates and mixtures thereof.

9. Method for the production of a composite material according to any of claims 3-5, wherein a substrate of inert material, for example a fabric-felt, is soaked with said mixture obtained according to said phases a) and b).

10. Composite material obtainable by means of the method defined in any of claims 3-8.

11. Binding resin as obtainable by means of said step a) of the method defined in claims 3-8, in the absence of the expanding agent.

12. Use of the binding resin defined in claim 10 as a finishing and/or coating material.

13. Method for the production of a composite material as defined in claims 1-2, through the following steps:
a′) mixing, at environment temperature and pressure, for a period between 2 and 5 minutes, a binding resin obtainable from the following components:
40-60% by weight of a combination of an hardening dust based on silica added with hardening agents selected from the group comprising esters of polyhydroxylic alcohols and esters of alkylene carbonates,
the remaining part being constituted by water and admixtures such as refractory clays based on aluminium silicate and/or organic and inorganic binders such as hydrates based on silicates, water-repellent agents,
b′) adding an amount between 0.1% and 90% of the total volume, of an inert material, as defined in claim 2;
c′) pouring said mixture in a mould, or soaking a substrate of inert material, such as a fabric-felt, with said mixture;
d′) allowing the polymerisation of the mixture, at a temperature between 15 and 35° C. for a period between 3 and 4 days;
e′) completing the polymerisation through stabilisation and curing for a period between 1 and 3 days, in a dryer at a temperature between 60 and 80° C., or for a period up to 15 days, at environment conditions.

14. Composite material obtainable by means of the method defined in claim 13.

15. Method for the production of a composite material as defined in claims 1-2, comprising the following steps:
a″) mixing, at environment pressure and temperature, for a period between 2 and 5 minutes, a binding resin obtainable from the following components:
40-60% by weight of a combination of hardening dust based on silica added with hardening agents selected from the group comprising esters of polyhydroxylic alcohols and alkylene carbonates esters,
the remaining part being constituted by water and admixtures such as refractory clays based on aluminium silicate and/or organic and inorganic binders such as hydrates based on silicates, water-repellent agents,
b″) adding an amount between 0.1% and 90% of the total volume, of an inert material, as defined in claim 2;
c″) pouring said mixture in a mould, or soaking with said mixture a substrate of inert material, such as a fabric-felt;
d″) allowing the polymerisation of the mixture, at a temperature between 15 and 35° C. for a period between 3 and 4 days;
e″) completing the polymerisation through stabilisation and curing for a period between 1 and 5 days, in a dryer at a temperature between 60 and 100° C.;
f″) separately mixing together, at environmental pressure and at a temperature below 40° C., for a period between 30 min and 1 h, a binding resin obtainable from the following components:
30-90% by weight of a mixture of various polyoils, polyethers and/or polyesters and/or oligomeric diamines,
1-5% by weight of a cataliser,
3-20% by weight of a cross-linking agent,
2-4% by weight of a stabiliser,
2-10% by weight of a superfluidifier,
3-20% by weight of a fire retardant agent,
0-6% by weight of an expanding agent,
0-5% by weight of a dye;
g″) adding to the mixture, at a temperature between 20° C. and 40° C., 30-250 parts by weight, with respect to 100 parts by weight of the mixture of step f″), of a MDI polymeric isocyanate (or a pre-polymer thereof);
h″) pouring in a mould, whose walls were covered with a layer of a material obtained by means of the phases from a″) to e″), an amount between 0.1% and 90% of the total free volume of the mould of an inert material, as defined in claim 2;
i″) pouring in the same mould a mixture as obtained by means of the phases f″) and g″);
l″) allowing the polymerisation of the mixture, at a temperature between 25° C. and 60° C. for a period between 5 and 45 minutes;
m″) allow the polymerisation to complete through stabilisation and curing for a period between 2 and 8 hours, in a dryer at a temperature between 60° C. and 110° C., or for a period up to 80 hours, at environment conditions.

16. Method for the production of a composite material according to claim 15, wherein, in the mixture of phase f″) of said method, said polyoils, polyethers and/or polyesters are chosen amongst those having a molecular weight between 200 and 6000; said oligomeric diamines are chosen amongst those with equivalent weight between 200 and 800; said cataliser is chosen amongst tertiary aliphatic amines, metallic materials based on bismuth or tin, quaternary ammonium salts, potassium salts; said cross-linking agent is chosen amongst ethilenglycols and/or alkanolamides; said stabiliser is chosen amongst silica copolymers; said superfluidifier is chosen amongst phosphoric or carbonic acid esters; said expanding agent is chosen amongst water, carbon dioxyde, penthanes, dispersions of microcapsules of thermoplastic nature containing liquids having low boiling point in a liquid vehicle; said 3-20 parts of a fire retardant agent are comprised of 2-10 parts of a liquid fraction, chosen amongst oxydrilated resins containing bromine and phosphorus, and of 1-10 parts of a solid fraction, chosen amongst aluminium trihydrate and/or magnesium oxydes and/or melamine dusts of various grain size; and said dye can have an organic and/or inorganic nature.

17. Composite material obtainable by means of the method as defined in claims 15 and 16.

18. Compositions, methods and uses according to any of claims from 1 to 17 and substantially as illustrated and described.
